(19) United States
(12) Patent Application Publication
(10) Pub. No.: US 2004/0156574 A1
(43) Pub. Date: Aug. 12, 2004

(54) Tunable and switchable optical devices

(76) Inventors: Ralph Alexander Betts, Meldreth (GB); Terry Bricheno, Saffron Walden (GB)

Correspondence Address: Timothy J Keefer, Wildman Harrold Allen & Dixon, 225 West Wacker Drive, Chicago, IL, 60606-1228, US

(21) Appl. No.: 10/472,096

(22) PCT Filed: Mar. 14, 2002
(86) PCT No.: PCT/GB02/01168

(30) Foreign Application Priority Data
Mar. 16, 2001 (AU) PR3737

(51) Int. Cl. G02B 6/00

(52) U.S. Cl. 385/11

(57) ABSTRACT

A range of tunable and switchable optical devices utilise liquid crystal variable wave plates to achieve tuning or switching of one or more parameters of the incident light. Such devices include various configurations of liquid crystal variable wave plates, birefringent walk off plates, birefringent wave plates, reflectors, lenses and others located in the light paths between optical fibres. A reciprocal optical component has a polarisation equaliser attached or adjacent to a fibre, or located between the fibre and a lens reducing the size and cost. Using equalisers with liquid crystal elements can avoid the need for separate liquid crystal devices for each of the polarisations. Switches, dynamic gain equalisers, attenuators, polarisation mode dispersion compensators and Fabry-Perot filters can also be created.

### FIELD OF THE INVENTION

The present invention relates to optical components, including tunable and switchable optical devices primarily for application in optical fibre systems and networks, to nodes incorporating such components, and to methods of operating such networks.

### BACKGROUND ART

Optical fibre transmission systems and networks are being rapidly deployed throughout the world. Greater and greater transmission capacities are required by customers and are being provided by manufacturers. To facilitate the increase in capacity, tunable and switchable optical components with greater and greater functionality are required. It is often convenient to achieve the required functionality by manipulating the state of polarisation of the light in the system.

Examples of such components include variable attenuators, variable gain equalisers, variable tap couplers, variable phase plates, optical crossbar switches and tunable add/drop multiplexers. Other applications, for example polarisation mode dispersion compensators and coherent receivers, will rely upon the ability to control the state of polarisation of the transmitted light at certain locations within the system, typically requiring rapid, accurate and stable electrical control as determined by monitors elsewhere in the system supplying control information according to some algorithm. Many possible embodiments of these components are suggested by prior art, however each of the prior art implementations has significant limitations compared with the implementations described hereunder.

For example, the classic means of polarisation control based upon mechanically rotated wave plates or mechanically adjusted wound-fibre waveplates are too slow for practical application (R Noe et al, “Polarisation mode dispersion compensation at 10, 20 and 40 Gbits with various optical equalizers”, Journal of Lightwave Technology, Vol 17, No 9, pp1602-1616, 1999). Controllers based on induced stresses in fibre (“fibre squeezers”) are faster (N G Walker and G R Walker, “Polarisation control for coherent communications”, Journal of Lightwave Technology, Vol 8, No 3, pp438-458, 1990), but tend to suffer from mechanical hysteresis and may constitute a reliability hazard.

Liquid crystal variable waveplates are non-mechanical, but early liquid crystal cells, often based upon nematic or twisted nematic liquid crystal materials (eg Patel U.S. Pat. No. 5,414,541) were also too slow.

More recent advances in liquid crystal technology, particularly relating to the development of the “ferroelectric” and “flexoelectric” materials have stimulated renewed interest in this approach for fast optoelectronic devices. However, in order to yield useful components for advanced optical systems, attention must also be directed to the detailed optical architecture of the proposed component. For example, it is often imperative to ensure that a component does not introduce significant differential group delay, resulting in polarisation mode dispersion (PMD). In other words components which involve polarisation diverse paths must ensure that the optical path lengths (or times of flight) for each state are substantially the same (unlike Pan U.S. Pat. No. 6,181,846). Insertion losses must be minimised by careful fibre to fibre imaging through the device (unlike Barnes, 1988). In addition, the component architecture must offer a clear route to low cost manufacture. Thus, for example, polarisation diverse architectures should seek to avoid large, costly, or complex birefringent routing crystals of the kind proposed in for example Wagner and Cheng (1980), Soref, Optics Letters 7, (4), p186 (1982), Wu (U.S. Pat. No. 5,963,291) and Pan (U.S. Pat. No. 5,727,109).

Other references include A B Carlson, “Communication systems”, McGraw Hill, 1986, particularly pp85-86 who describes tapped delay line electronic filters, Soref, Optics Letters 7, (4), p186 (1982) who describes polarisation equalisation using bulk optics, Frisken (U.S. Pat. No. 6,014,475) and Frisken et al (U.S. Pat. No. 6,263,131) who describes polarisation equalisation adjacent to fibre but only in the context of circulators, or non-reciprocal devices, and Barnes, El. Let, 24, (23), p1427 (1988) who describes liquid crystal control in fibre-based devices (but with no polarisation equalisation, and no imaging fibre to fibre).

Wagner and Cheng, App. Opt. 19, (17), p2921 (1980) describe polarisation based switching using collimated beam arrangements, and Wu (U.S. Pat. No. 6,337,934), Patel (U.S. Pat. No. 5,414,541) and Fujii, Phot. Tech. Lett., 5, (6), p715 (1993) describe segmented liquid crystal elements for polarisation diversity,

Pan (U.S. Pat. No. 6,181,846) describes a reflective variable optical attenuator, but it suffers from PMD. Pan's earlier transmissive voa (U.S. Pat. No. 5,727,109) relies on collimated expanded beams through angled birefringent prisms. Wu (U.S. Pat. No. 5,963,291) shows an example using collimated beams.

Known PMD compensators include one shown in Walker (U.S. Pat. No. 4,988,169) (1987)—an “endless” polarisation controller. Clark (U.S. Pat. No. 5,005,952) (1988)—shows a nematic Liquid crystal polarisation controller. Rumbaugh (U.S. Pat. No. 4,979,235) (1989) also shows a liquid crystal polarisation controller. Noe et al “PMD compensation with various optical equalisers” J. Lightwave Tech 17, (9), p1602 (1999) shows ferroelectric liquid crystal retarders.

Known gain equalisers are shown in Huang et al “Performance of a liquid-crystal harmonic equalizer” Optical Fibre Communications Conference 2001, Paper PD29 and Frisken et al “Low loss, polarisation independent, dynamic gain equalisation filter” Optical Fibre Communications Conference 2000, Paper WM14.

Known tunable Fabry-Perot filters include those shown in Patel (U.S. Pat. No. 5,111,321), which has segmented LC cells, Rumbaugh (U.S. Pat. No. 5,710,655) which uses bulk optics and collimators, and Hirabayashi et al, J. Lightwave Tech., 11, p2033 (1993) which again uses bulk optics and collimators.

### SUMMARY OF THE INVENTION

It is an object of the invention to provide improved apparatus and methods.

According to a first aspect of the invention, there is provided a substantially reciprocal optical component comprising at least one or more waveguides, one or more of which has a polarisation equaliser attached or adjacent, the polarisation equaliser having at least a polarisation dependent displacement element which splits light exiting the waveguide to which it is attached or adjacent into two substantially spatially separate beams with substantially orthogonal polarisations and at least one polarisation manipulation element arranged to equalise the polarisations of the two beams.

A significant advantage of this scheme is that the length of the walk off crystal can be considerably shorter than alternative schemes where the polarisation is equalised after a collimating lens. This reduces size and cost and improves optical performance and manufacturability of the component.

A second aspect provides a substantially reciprocal optical component comprising at least one or more waveguides, at least one imaging element to couple light from at least one waveguide to at least one waveguide, at least one polarisation equaliser located between a waveguide and the first imaging element that light exiting this waveguide encounters, the polarisation equaliser having at least a polarisation dependent displacement element which splits light exiting the waveguide into two substantially spatially separate beams with substantially orthogonal polarisations and at least one polarisation manipulation element arranged to equalise the polarisations of the two beams.

Preferred additional features include the polarisation manipulation component being a polarisation rotation component, and/or one or more liquid crystal elements to achieve tuning or switching of one or more parameters of incident light and all or part of the light exits through one or more of the waveguides.

An advantage of using equalisers with liquid crystal elements is that liquid crystal elements are inherently polarisation dependent. Without an equaliser, separate liquid crystal devices would be needed for each of the polarisations. (As mentioned in Patel, U.S. Pat. No. 5,111,321). This, and the use of shorter walk off crystal, enable the device to be much more compact and easier to manufacture. Additional elements can be provided in the optical path or paths such as a passive spacer, for setting up the imaging for example, or a birefringent element.

The component can be arranged as an optical switch. It can have four of the waveguides, arranged as a two by two crossbar optical switch, each of the waveguides being provided with a respective one of the equalisers, first and second of the waveguides being substantially parallel, the equaliser for the first waveguide being arranged to equalise the polarisation of light exiting the equaliser of the first waveguide substantially orthogonally to the light exiting the equaliser of the second waveguide, third and fourth of the waveguides being substantially parallel, and each being provided with a respective one of the equalisers, the equaliser for the third waveguide being arranged to equalise the polarisation of light exiting the equaliser of the third waveguide substantially orthogonally to the light exiting the equaliser of the fourth waveguide, the switch having a variable polarisation rotation element and at least one further polarisation dependent displacement element, the switch being arranged such that in a first switched state, the first waveguide couples to the third waveguide and the second waveguide couples to the fourth waveguide, or in a second switched state, the first waveguide couples to the fourth waveguide and the second waveguide couples to the third waveguide.

Another preferred feature is that the polarisation rotation element is a liquid crystal variable wave plate. Advantages of this type of switch are compact size, low cost, low electrical power consumption, relatively high speed and low hysteresis. It can have a lens or lenses disposed between the waveguides to couple the light.

Another aspect provides a substantially reciprocal optical component having substantially zero polarisation mode dispersion, and comprising at least one or more waveguides, one or more of which has a polarisation dependent displacement element attached or adjacent.

An advantage is that it enables a more compact component as the polarisation displacement does not need to be large to move out of alignment with the waveguide and destroy the coupling, or cause attenuation.

Another aspect provides a substantially reciprocal optical component having substantially zero polarisation mode dispersion, and comprising at least one or more waveguides, at least one imaging element to couple light from at least one waveguide to at least one waveguide and at least one polarisation dependent displacement element located between the waveguide and the first imaging element that light exiting this waveguide encounters.

This can be substantially transmissive, or substantially reflective. It can be arranged as a variable attenuator, and having a first and second of the waveguides each provided with one of the polarisation dependent displacement elements, the attenuator being arranged to couple between the first and second waveguides and having a variable polarisation manipulation element disposed between the first and second waveguides, the polarisation dependent displacement elements being arranged such that for each polarisation, light coupled through the device transits the same optical path length.

The polarisation manipulation element can be a liquid crystal variable wave plate. It can have a fixed half wave plate disposed between the polarisation dependent displacement element to invert the operation of the attenuator. This inversion means that where it was previously high attenuation it is now low attenuation and vice versa.

Another aspect provides an attenuator array comprising multiple substantially parallel attenuators each having its own imaging element or elements, or some or all of the attenuators sharing the same imaging element or elements.

Another aspect provides a polarisation mode dispersion (PMD) compensator for compensating higher order PMD comprising an input fibre followed by a series of one or more optical components as set out above in the first aspect, each component being arranged as an endless polarisation controller, and each being followed by a birefringent element.

This brings the advantages of liquid crystal based control of fast speed of control, low power consumption, low cost and low hysteresis.

Another aspect provides an optical dynamic gain equaliser comprising at least a first waveguide, a series of at least one variable tap couplers, delay elements to provide a fixed delay and a variable delay to each tapped beam and to a final untapped beam, a combiner arranged to recombine all the tapped beams and the untapped beam and couple the recombined light into the first or another waveguide.

An advantage of this is flexibility in matching a wide range of channel characteristics, without the complexity of series or parallel coupled optical filters.

Preferred additional features include a polarisation splitter after the first waveguide, liquid crystal variable tap couplers for each split polarised beam and a liquid crystal variable wave plate to provide the variable delays. It may have a reflective or transmissive configuration.

Another aspect provides a waveguide coupled tunable Fabry-Perot filter, having a first of the waveguides provided with one of the equalisers, a second of the waveguides provided with another of the equalisers, imaging element or elements to couple light between the waveguides and to provide a substantially collimated expanded beam within the component, the component having a tunable Fabry Perot filter having two substantially parallel reflectors located in the substantially collimated expanded beam and a liquid crystal variable waveplate located between the reflectors to provide a variable phase delay to the light.

In broad terms, aspects of the present invention encompass electrically tunable and switchable optical devices where the tuning and switching is achieved by varying the retardation of one or more liquid crystal wave plates. They encompass a range of components having novel configurations of optical elements including liquid crystal variable wave plates, birefringent walk off plates, birefringent wave plates, reflectors, lenses and others located in the light paths between a plurality of optical fibres.

The benefits can be appreciated at the system or network level, so other aspects of the invention provide a node for a network, incorporating such components, and a method of operating such a network by controlling the optical components to tune optical characteristics or to route data traffic.

Any of the preferred features may be combined with any of the aspects as would be apparent to those skilled in the art.

### BRIEF DESCRIPTION OF THE DRAWINGS

FIG. 1 shows a prior art liquid crystal variable wave plate (Meadowlark Optics Inc.).

FIG. 2 shows a fibre coupled variable wave plate.

FIG. 3 shows a prior art fibre coupled endless polarisation controller using four variable wave plates having the functionality described by Walker (U.S. Pat. No. 4,988,169) implemented according to Clark and Samuel (U.S. Pat. No. 5,005,952).

FIG. 4 shows a first order PMD compensator using a polarisation controller, polarisation splitter and a variable delay line.

FIG. 5 shows a higher order PMD compensator using multiple polarisation controllers and lengths of birefringent fibre.

FIG. 6 shows a prior art polarisation rotator using a variable wave plate and a quarter wave plate (Meadowlark Optics Inc.).

FIG. 7 shows a transmissive variable attenuator using a liquid crystal variable wave plate and the polarisation diagram for propagation through this device.

FIG. 8 shows a reflective variable attenuator using a liquid crystal variable wave plate and the polarisation diagram for propagation through this device.

FIG. 9 shows a two by two crossbar optical switch, and associated polarisation diagrams.

FIG. 10 shows a tunable gain equalizer using a tapped delay line principle.

FIG. 11(a) shows a bulk, polarisation dependent, tunable Fabry-Perot filter based on varying the optical path in a cavity. FIG. 11(b) shows a polarisation independent tunable add/drop multiplexer based on the tunable filter in FIG. 11(a). FIG. 11(c) shows the transmission of such a device versus wavelength.

### DETAILED DESCRIPTION

A number of preferred implementations of the invention providing tunable and switchable optical devices will now be described.

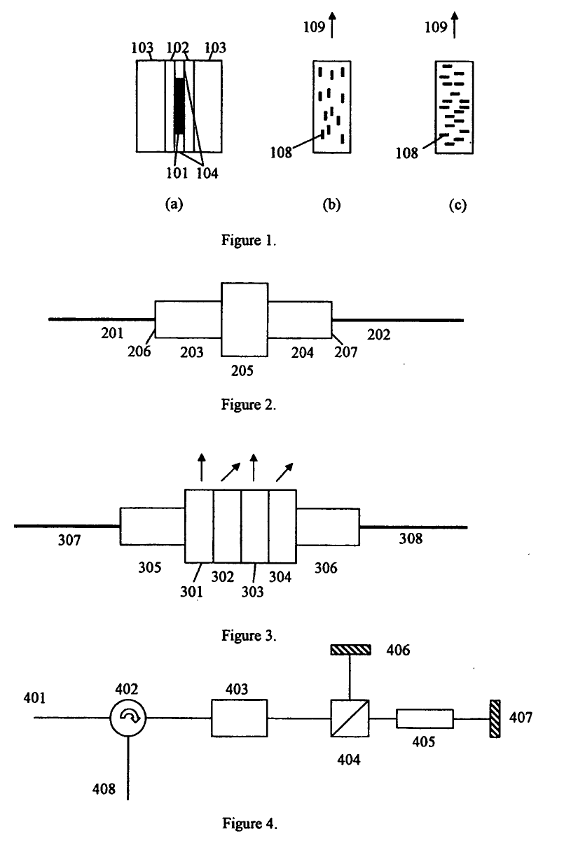

FIG. 1(a) shows a prior art liquid crystal variable wave plate of the type available from manufacturers (for example Meadowlark Optics Inc.). The variable wave plate consists of a layer of liquid crystal material 101, usually of the nematic type, transparent conducting layers, usually Indium Tin Oxide (ITO), 102, glass plates, 103, and spacers, 104. In addition, the surfaces of the glass and the ITO may be anti-reflection coated. Furthermore the ITO layers are coated or treated to cause the liquid crystal molecules to align in a particular direction along the surface in the absence of applied electric field. The liquid crystal molecules are long chain, anisotropic molecules with an optical axis along the major axis of the molecule. The orientation of the molecules is defined by the surfaces contacting the liquid crystal and the electric field applied.

When no field is applied, the liquid crystal molecules, 108 align along the y direction, 106 as shown in FIG. 1(b). This direction is the optical axis of the variable wave plate shown by arrows, 109. When an electric field is applied in the z direction, 107, the liquid crystal molecules align with the electric field as shown in FIG. 1(c). By varying the electric field, the retardance of the wave plate can be varied. By choosing the liquid crystal material and thickness, appropriately, a desired range of retardance can be provided.

FIG. 2 shows a simple implementation of an optical fibre variable wave plate which consists of two fibres, 201, 202, two lenses, 203, 204, and a variable wave plate of the type described above, 205. Provided that the fibres and lenses are positioned to couple light efficiently from one fibre to the other, this implementation will operate efficiently as a fibre variable wave plate. It may be preferable in this and the following devices to polish the ends of the lenses, 206, 207 and the contacting fibres at a slight angle and to offset the fibres from the centre of the lenses to reduce back reflection.

It has been demonstrated [Walker and Walker, 1990] that four variable wave plates give endless polarisation control. Their implementation used fibre squeezers. FIG. 3 shows an endless polarisation controller (EPC) using four liquid crystal variable waveplates, 301, 302, 303, 304, two lenses, 305, 306 and two fibres 307, 308. The optical axes of the waveplates with no field applied viewed along the z direction, 107, is shown by the arrows. The first axis being in the y direction, the second in the x y plane at 45 degrees to x and y directions. The third axis is the same as the first and the fourth is the same as the second. This configuration gives the simplest provision of the most general polarisation control (arbitrary polarisation in to arbitrary polarisation out and the capability to achieve endless polarisation control with appropriate control schemes). It will be apparent to those skilled in the art that less general polarisation control requirements (eg fixed linear in to arbitrary out, arbitrary in to fixed linear out and endless) can be achieved with fewer waveplate elements.

FIG. 4 shows a first order polarisation mode dispersion (PMD) compensator using an endless polarisation controller (EPC) of the type described above. The light signal enters fibre 401 and travels through optical circulator, 402 to endless polarisation controller, 403 as described above. The signal is then split into two orthogonal polarisations by polarisation multiplexer, 404. One polarisation is reflected by reflector 406, and the other passes through a variable delay line, 405 and is reflected by reflector 407. The signal passes back along the same paths until it is passed to output fibre 408 by the optical circulator 402. By controlling the endless polarisation controller and the variable delay line, good first order PMD compensation can be achieved.

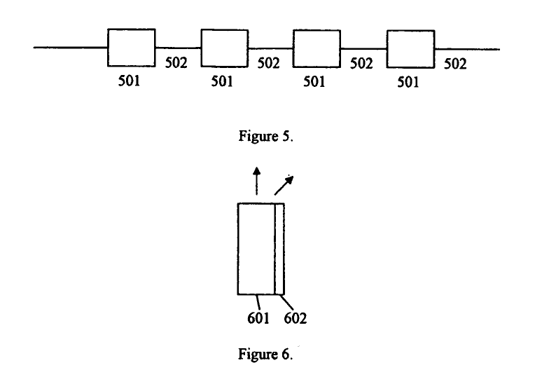

Higher order PMD compensation has been demonstrated [R Noe et al, 1999] using stepper motor controlled polarisation controllers and birefringent fibre. FIG. 5 shows a higher order PM) compensator using liquid crystal endless polarisation controllers (EPCs), 501, of the type described above and lengths of birefringent fibre, 502. This scheme offers the highest functionality and performance in compensating practical higher order PMD in installed systems.

FIG. 6 shows prior art (Meadowlark Optics Inc.) which provides rotation of a linear input polarisation to an arbitrary linear output polarisation in the x y plane. The configuration requires a variable wave plate, 601, a quarter wave plate 602, and the linearly polarized input light to be polarized in a direction 45 degrees to the x and y axes. The wave plate axis is in the y direction and the quarter wave plate axis is in the x y plane at 45 degrees to the y direction.

Pan [U.S. Pat. No. 5,276,747] has described a reflective optical attenuator using a liquid crystal cell and a birefringent walk off plate. This attenuator however has inherent PMD due to one polarisation experiencing two walk offs and the other experiencing none. We describe here transmissive and reflective attenuators which have no inherent PMD.

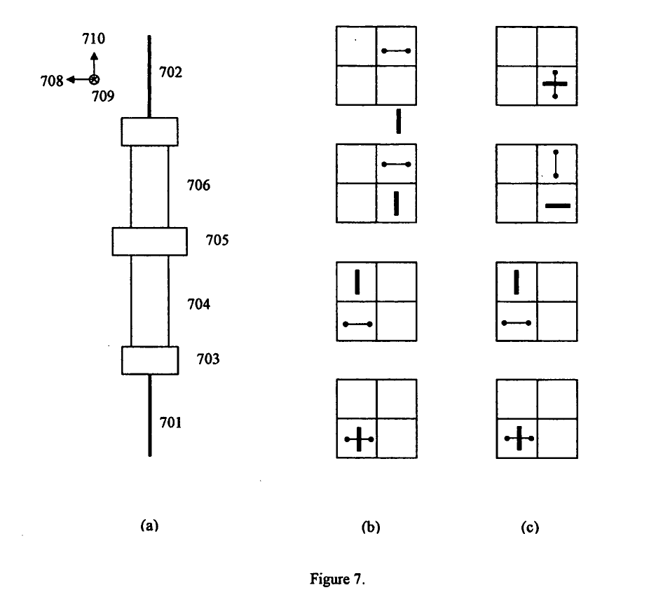

FIG. 7(a) shows a transmissive attenuator using a liquid crystal variable wave plate. This device consists of two fibres 701 and 702, a birefringent crystal walk off plate (eg rutile or calcite), 703, with its walk off axis in the y direction, a lens (eg a GRIN or graded index lens such as are available from NSG, Japan), 704, a liquid crystal variable wave plate such as described above, 705, with its axis at 45 degrees to the x and y directions, a further lens, 706 and a further birefringent crystal walk off plate with its walk off axis in the -y direction. In this diagram the coordinate system is as shown in FIG. 7(a) which shows the x direction, 708, the y direction (out of paper), 709 and the z direction 710 (the direction of propagation).

The polarisation diagrams, FIG. 7(b) and 7(c) show the evolution of orthogonal (x and y) polarisations through the device looking along the z axis at a section in the x y plane from one fibre (the bottom diagram) through walk off plate 703, lenses and liquid crystal element 704, 705, 706 and walk off plate 707 to the other fibre (the top diagram). In FIG. 7(b) the liquid crystal wave plate is biased to have zero retardance and the polarisations do not recombine (the device has large attenuation). In FIG. 7(c) the liquid crystal wave plate is biased to be a half wave plate and the polarisations recombine (the device has low attenuation). When the polarisation states recombine and light is transmitted, the optical paths travelled by the two polarisations are equal and the device has inherently zero PMD. By varying the bias and therefore the retardation of the wave plate, variable attenuation is achieved. In practice, it is preferable to use a compensating fixed wave plate adjacent to the liquid crystal element to allow biasing of the liquid crystal wave plate and fixed wave plate combination between zero and π radians. The operation of the attenuator can be inverted (the high and low attenuation states reversed) by adding a further π radians retardance to the fixed wave plate.

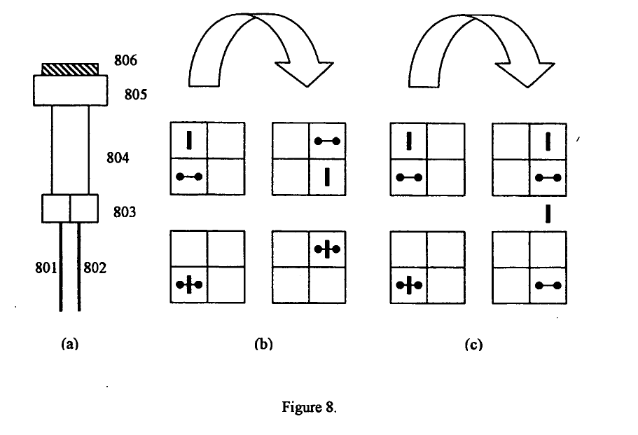

FIG. 8(a) shows a reflective attenuator. The coordinate system is the same as for FIG. 7. This device consists of two fibres 801 and 802, a split birefringent crystal walk off plate (eg rutile or calcite), 803, with its walk off axis for fibre 801 in the y direction and for fibre 802 in the -y direction, a lens (eg a GRIN or graded index lens such as are available from NSG, Japan), 804, a liquid crystal variable wave plate such as described above, 805, with its axis at 45 degrees to the x and y directions and a glass block with a broad band reflector (eg a dielectric stack) on the rear surface, 806. Preferably this surface will be at a slight angle to the front surface (eg 0.5 degrees) to deflect the beam in the horizontal plane. This minimises transmission ripple due to optical cavities.

The polarisation diagrams show the evolution of orthogonal (x and y) polarisations through the device looking along the z axis. When the wave plate is biased to provide π radians of retardation for a double pass, 807, the polarisations recombine. When the wave plate is biased to provide no retardation, 808, the polarisations separate. For light passing through the device, the two polarisations experience substantially identical times of flight resulting in inherently zero PMD. The position of the two fibres, 801 and 802 should be optimised so that with π radians of retardation for a double pass, light is coupled with maximum efficiency from one fibre to the other. By varying the bias and therefore the retardation of the wave plate, variable attenuation is achieved. Again, in practice, it is preferable to use a compensating fixed wave plate adjacent to the liquid crystal element to allow biasing of the liquid crystal wave plate and fixed wave plate combination between zero and π radians for a double pass. The operation of the attenuator can be inverted (the attenuation states reversed) by adding a further n/2 radians retardance to the fixed wave plate.

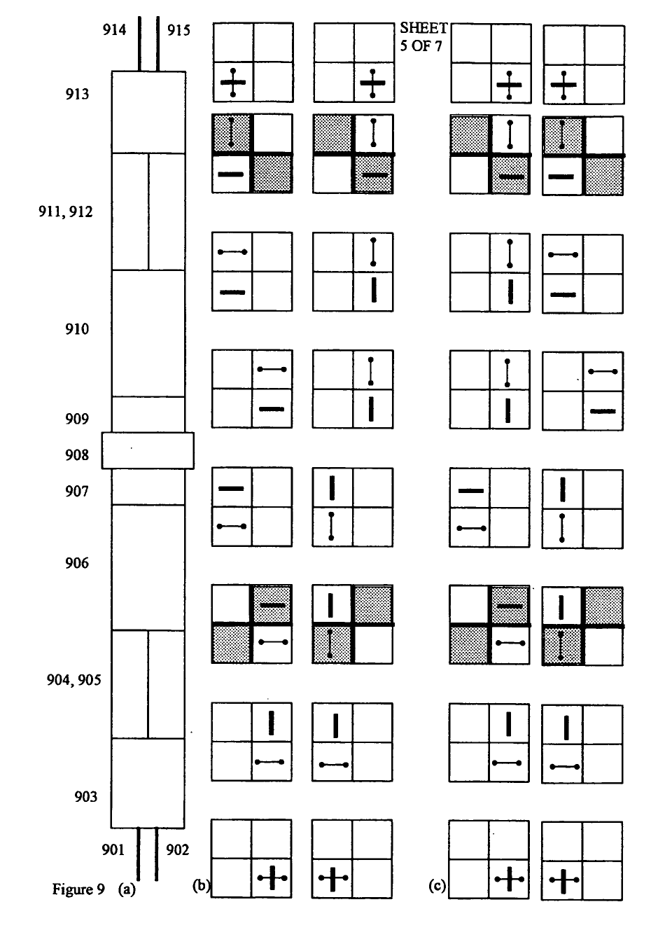

FIG. 9(a) shows a two by two crossbar switch. The coordinate system is the same as for FIG. 7. It consists of input fibres 901, 902. These may be large MFD fibres or fibres with thermally expanded cores (TECs) at the point that they butt to walk off crystal 903 in a manner similar to prior art in non-reciprocal optical devices (Frisken, U.S. Pat. No. 6,014,475). The mode field diameter at this point is preferably around 20 micrometers. This allows the input light to be spatially separated into orthogonal polarisations (vertical and horizontal) by the walk off crystal which has its walk off axis in the y (vertical) direction. The light then passes through a half wave plate, 904/glass, 905 combination or similar to equalize the polarisations from each fibre but with the polarisation of light from fibre 901 orthogonal to the polarisation of light from fibre 902. This requires a plate comprising two half wave plates and two glass plates arranged in a quadrant—the half wave plates are shown dot shaded in FIG. 9(b). It then passes through another walk off plate, 906 with its walk off axis in the x direction. The light is then collimated by a lens, 907. It then passes through a liquid crystal variable wave plate, 908 with its axis at 45 degrees to the x and y directions. An identical set of components is located on the other side of the variable wave plate (909 to 915).

The polarisation diagrams (FIG. 9(b)) show the evolution of orthogonal polarisations through the device. When the retardation of the variable wave plate is zero, the polarisations recombine. When the retardation of the variable wave plate is n radians, the polarisation of light is rotated by 90 degrees on passing through the wave plate. The polarisations recombine, but the image is walked off by the walk off plate 910. The length of the walk off plate 810 is chosen such that the light recombines at optical fibre 914 rather than 915. The polarisation diagram shows both cross and bar states. For light passing through the device and for all states of the switch the two polarisations experience substantially identical times of flight resulting in inherently zero PMD. As well as being a two by two crossbar switch, this device can also clearly function as a 2 by 2 variable tap coupler. Again, in practice, it is preferable to use a compensating fixed wave plate adjacent to the liquid crystal element to allow biasing of the liquid crystal wave plate and fixed wave plate combination between zero and π radians for a double pass. The operation of the switch can be inverted (the switch states reversed) by adding a further π/2 radians retardance to the fixed wave plate. Extensions to more ports are possible.

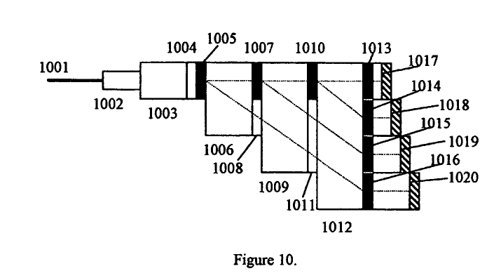

FIG. 10 shows a tunable equalizer using a tapped delay line or transversal filter principle. This principle is well established in the filtering of electronic signals and offers excellent flexibility in matching widely varying filtering requirements [A B Carlson, 1986]. Three liquid crystal variable wave plates, 1005, 1007 and 1010 set the tap percentage and four liquid crystal variable wave plates, 1013, 1014, 1015, 1016 set the phase delay for each path.

The device is a reflective device. There is a single fibre input and output, 1001. This is butted to a lens, 1002, preferably a GRIN lens, which collimates the light. The light then passes through a walk off plate, 1003, which has its walk off axis in the x direction This walk off plate separates the light into two orthogonal linear polarisations (x and y). The light then passes through a glass/half wave plate combination or similar, 1004, which equalizes the polarisations. The light then passes through a liquid crystal variable wave plate, 1005 as described above with its axis at 45 degrees to the x and y directions. This variable wave plate varies the amount of power in the x and y polarisations and the following walk off plate walks off the y polarized light and together these form a variable tap coupler. The light then travels through another walk off plate, 1006 with its walk off axis in the -y direction. The x polarized light which was not walked off passes through a variable wave plate 1007 and the y polarized light which was walked off passes through glass plate 1008. All light paths then pass through a further walk off plate 1009. Again, the x polarized light which was not walked off passes through a variable wave plate 1010 and the y polarized light which was walked off passes through glass plate 1011. All light paths then pass through a further walk off plate 1012. After passing through this walk off plate, there are eight separate light beams. Four pairs of spots (upper and lower corresponding to the upper and lower output of walk off plate 1003) then pass through four liquid crystal variable wave plates, 1013, 1014, 1015, 1016 with their axes in the y direction, and four glass blocks with relective layers 1017, 1018, 1019, 1020. The lengths of the glass blocks are chosen so that the delay between path 1 and 2 is T, path 1 and 3 is 2T, path 1 and 4 is 3T giving a fundamental free spectral range approximately equal to the wavelength range over which equalization is desired. Light then travels back to the input fibre. A reflective configuration is convenient if this filter is to be used at the mid stage of an Erbium doped fibre amplifier (EDFA). If a transmissive functionality is required, a circulator can be used or a more complex transmissive configuration can be implemented. The extension to a greater (or fewer) number of taps is obvious to those skilled in the art. More complex transmissive implementations will also be obvious to those skilled in the art.

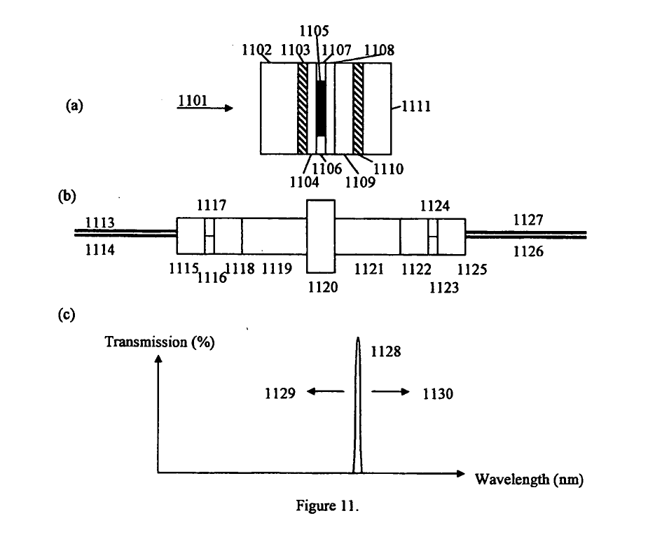

FIG. 11(a) shows a bulk, polarisation dependent, tunable Fabry-Perot filter based on varying the optical path in a cavity with a liquid crystal variable wave plate. Light is incident as shown by the arrow, 1101, onto a glass plate, 1102. A broadband dielectric reflector stack, 1103 is deposited on the right hand side of the glass plate, 1102, and an ITO layer, 1104 is deposited on the dielectric reflector stack. A liquid crystal layer, 1105, follows, the thickness of which is set by spacers, 1106, 1107. To the right of the liquid crystal layer is a further ITO layer with anti-reflection layers, 1108 deposited on glass plate 1109. This is attached to a further block of glass, 1111, with a broadband dielectric reflector stack, 1110 deposited on its left surface. The ITO surfaces are treated to cause the liquid crystal to align in the y direction for no applied electric field. This configuration provides a polarisation dependent Fabry-Perot filter with the cavity and free spectral range defined by the spacing of the broadband reflector stacks. This filter has a narrow transmission peak which can be tuned by varying the electrical bias on, and therefore the retardance of the liquid crystal variable wave plate.

FIG. 11(b) shows a polarisation independent tunable add/drop multiplexer based on the tunable filter in FIG. 11(a). The device consists of a first fibre, 1113 and a second fibre, 1114 which are parallel with their axes in the z direction and the line joining the cores in a horizontal (x) direction. These fibres have thermally expanded cores, preferably with a mode field diameter of approximately 20 micrometers, at the point that they are attached, preferably by a transparent epoxy, to walk off plate 1115 with its walk off axis in the y direction. Attached to the walk off plate is a glass, 1116/half wave plate, 1117 combination, or similar to equalize the polarisations. A further walk off plate, 1118, with its walk off axis in the x direction follows. This walk off plate is then attached to a lens, 1119, which is then attached to the filter assembly depicted in FIG. 11(a), 1120. A similar fibre, crystal stack and lens assembly, 1121 to 1127 is attached to the other side of the filter assembly. The fibres and lenses are aligned for optimum coupling between fibre 1113 and 1126 (and between fibre 1114 and 1127) for the transmission peak.

FIG. 11(c) shows the transmission of such a device versus wavelength. By proper selection of the cavity dimensions and liquid crystal material and thickness, tuning the transmission peak, 1128 across a desired wavelength range can be achieved as shown by arrows, 1129 and 1130. A narrow transmission band will be coupled from fibre 1113 to 1126 and from 1114 to 1127. The remainder of the wavelength range will be coupled from fibre 1113 to 1114 and from fibre 1126 to 1127.

All devices described above are reciprocal so any reference to input and output can be reversed and the device will have the same functionality.

When the terms “attach” or “butt” are used in reference to optical components above, unless otherwise stated, the preferred method for doing this is with an optically transparent epoxy.

Above has been described a range of tunable and switchable optical devices that utilise liquid crystal variable wave plates to achieve tuning or switching of one or more parameters of the incident light. Such devices include various configurations of liquid crystal variable wave plates, birefringent walk off plates, birefringent wave plates, reflectors, lenses and others located in the light paths between optical fibres. A reciprocal optical component has a polarisation equaliser attached or adjacent to a fibre, or located between the fibre and a lens, to reduce the size and cost. Using equalisers with liquid crystal elements can avoid the need for separate liquid crystal devices for each of the polarisations. Switches, equalisers, attenuators, polarisation mode dispersion compensators and Fabry-Perot filters can also be created.

It will be appreciated by those skilled in the art that although the invention has been described with reference to specific examples, the invention may be embodied in many other forms without departing from the scope of the claims.

1. A substantially reciprocal optical component comprising at least one or more waveguides, one or more of which has a polarisation equaliser attached or adjacent, the polarisation equaliser having at least a polarisation dependent displacement element which splits light exiting the waveguide to which it is attached or adjacent into two substantially spatially separate beams with substantially orthogonal polarisations and at least one polarisation manipulation element arranged to equalise the polarisations of the two beams.

2. A substantially reciprocal optical component comprising at least one or more waveguides, at least one imaging element to couple light from at least one waveguide to at least one waveguide, at least one polarisation equaliser located between a waveguide and the first imaging element that light exiting this waveguide encounters, the polarisation equaliser having at least a polarisation dependent displacement element which splits light exiting the waveguide into two substantially spatially separate beams with substantially orthogonal polarisations and at least one polarisation manipulation element arranged to equalise the polarisations of the two beams.

3. The optical component of claim 1 or claim 2, the polarisation manipulation element comprising a polarisation rotation element.

4. The substantially reciprocal optical component of any preceding claim, having one or more liquid crystal elements to achieve tuning or switching of one or more parameters of incident light and all or part of the light exits through one or more of the waveguides.

5. The optical component of claim 4 having additional elements in the optical path or paths.

6. The optical component of any preceding claim, arranged as an optical switch.

7. The optical component of any preceding claim, having four of the waveguides, arranged as a two by two crossbar optical switch, each of the waveguides being provided with a respective one of the equalisers, first and second of the waveguides being substantially parallel, the equaliser for the first waveguide being arranged to equalise the polarisation of light exiting the equaliser of the first waveguide substantially orthogonally to the light exiting the equaliser of the second waveguide, third and fourth of the waveguides being substantially parallel, and each being provided with a respective one of the equalisers, the equaliser for the third waveguide being arranged to equalise the polarisation of light exiting the equaliser of the third waveguide substantially orthogonally to the light exiting the equaliser of the fourth waveguide, the switch having a variable polarisation rotation element and at least one further polarisation dependent displacement element, the switch being arranged such that in a first switched state, the first waveguide couples to the third waveguide and the second waveguide couples to the fourth waveguide, or in a second switched state, the first waveguide couples to the fourth waveguide and the second waveguide couples to the third waveguide.

8. The optical component of claim 7 the polarisation rotation element comprising a liquid crystal variable wave plate.

9. The optical component according to any preceding claim having a lens or lenses disposed between the waveguides to couple the light.

10. A substantially reciprocal optical component having substantially zero polarisation mode dispersion, and comprising at least one or more waveguides, one or more of which has a polarisation dependent displacement element attached or adjacent.

11. A substantially reciprocal optical component having substantially zero polarisation mode dispersion, and comprising at least one or more waveguides, at least one imaging element to couple light from at least one waveguide to at least one waveguide and at least one polarisation dependent displacement element located between the waveguide and the first imaging element that light exiting this waveguide encounters.

12. The optical component of claim 10 or 11 which is substantially transmissive.

13. The optical component according to claim 10 or 11 which is substantially reflective.

14. The optical component of any of claims 10 to 13 arranged as a variable attenuator, and having a first and second of the waveguides each provided with one of the polarisation dependent displacement elements, the attenuator being arranged to couple between the first and second waveguides and having a variable polarisation manipulation element disposed between the first and second waveguides, the polarisation dependent displacement elements being arranged such that for each polarisation, light coupled through the device transits the same optical path length.

15. The optical component of claim 14, the polarisation manipulation element comprising a liquid crystal variable wave plate.

16. The optical component of claim 14 or 15 having a fixed half wave plate disposed between the polarisation dependent displacement elements to invert the operation of the attenuator.

17. An attenuator array comprising multiple substantially parallel attenuators as set out in any of claims 14 to 16, each having its own imaging element or elements.

18. An attenuator array comprising multiple substantially parallel attenuators as set out in any of claims 14 to 16, some or all of the attenuators sharing the same imaging element or elements.

19. A polarisation mode dispersion (PMD) compensator for compensating higher order PMD comprising an input fibre followed by a series of one or more optical components as set out in claim 4 or any claim depending on claim 4, each component being arranged as an endless polarisation controller, and each being followed by a birefringent element.

20. An optical dynamic gain equaliser comprising at least a first waveguide, a series of at least one variable tap couplers, delay elements to provide a fixed delay and a variable delay to each tapped beam and to a final untapped beam, a combiner arranged to recombine all the tapped beams and the untapped beam and couple the recombined light into the first or another waveguide.

21. The dynamic gain equaliser of claim 20 having a polarisation splitter after the first fibre and having liquid crystal variable tap couplers for each split polarised beam and having a liquid crystal variable wave plate to provide the variable delays.

22. The dynamic gain equaliser according to claim 20 or 21, having a reflective configuration.

23. The dynamic gain equaliser according to claim 20 or 21 having a transmissive configuration.

24. The dynamic gain equaliser of any of claims 20 to 23, and comprising at least one imaging element to couple light from the first waveguide to the same or to another waveguide, at least one polarisation equaliser located between the first waveguide and the first imaging element that light exiting this waveguide encounters, the polarisation equaliser having at least a polarisation dependent displacement element which splits light exiting the waveguide into two substantially spatially separate beams with substantially orthogonal polarisations and at least one polarisation manipulation element arranged to equalise the polarisations of the two beams.

25. The component of any of claims 1 to 5, arranged as a waveguide coupled tunable Fabry-Perot filter, having a first of the waveguides provided with one of the equalisers, a second of the waveguides provided with another of the equalisers, imaging element or elements to couple light between the waveguides and to provide a substantially collimated expanded beam within the component, the component having a tunable Fabry Perot filter having two substantially parallel reflectors located in the substantially collimated expanded beam and a liquid crystal variable waveplate located between the reflectors to provide a variable phase delay to the light.

26. The component of claim 25, arranged as an add drop multiplexer, having two additional waveguides and associated equalisers to capture light reflected from the Fabry-Perot filter.

27. A node for an optical network, incorporating one or more of the optical components of any preceding claim.

28. A method of operating the optical network having the node as set out in claim 27, having the step of controlling the one or more optical components to tune optical characteristics or to route data traffic.
